(19) United States
(12) Patent Application Publication
(10) Pub. No.: US 2008/0286023 A1
(43) Pub. Date: Nov. 20, 2008

(54) Method and System for Rfid Label Printing

(75) Inventor: Gaoren Lv, Shenzhen (CN)

Correspondence Address: GLOBAL IP SERVICES, 7285 W. Eagle Court, Winton, CA, 95388, US

(73) Assignee: POSTEK ELECTRONICS CO., LTD., Shenzhen (CN)

(21) Appl. No.: 11/719,394

(22) PCT Filed: Jul. 26, 2006
(86) PCT No.: PCT/CN2006/001862

§ 371 Date: May 15, 2007

(30) Foreign Application Priority Data
Jul. 28, 2005 (CN) 200510036260.5

(51) Int. Cl. B41J 11/44; G06K 7/08

(52) U.S. Cl. 400/76; 235/451

(57) ABSTRACT

The present invention relates to a RFID label printing system, comprising a label printer with a printing control panel, an antenna, a RF read-write module and a RFID label with loop, and a read-write interface and non-volatile memory. And a method for RFID label printing with comprises the steps of: A1) configuring printing contents; A2) acquiring printing contents by the printer control panel; A3) the RF read-write module communicating with RFID label in terms of RF signal via antenna; A4) the loop sensing the RF information, and writing information into the non-volatile memory via the read-write interface. The RF chip is installed on the label, the RF read-write module is configured on the printer, when printing label, user may read and write RF chip via the RF read-write module to stick RFID label with various information and data on the goods and merchandises, and it is convenient for the flow of goods and merchandises. A USB interface is also provided on the RIFD label printer, the label printer may read information stored in external USB storage via the USB interface, for convenience, user can transfer the label contents edited on the computer host to the printer via the USB storage.

### TECHNICAL FIELD

The present invention relates to printing technology, more particularly, relates to a method and system for RFID label printing.

### BACKGROUND OF THE INVENTION

Label printer is a special apparatus for printing stick-on label, scutcheon, drop, price label, and labels for consigned goods. Label printer is different from general file printers; it is commonly used at industrial side such as, production line and warehouse etc, and with function of printing information by fixed pattern, such as printing barcode, characters and graphics, etc. When processing, labels must be put close to the barcode scanner, this will cause a lot of inconvenience, for example, when processing a large amount of goods, each of the goods must be put close to the barcode scanner for reading barcodes, this will affects working efficiency. Commonly, label printer is often provided with a Flash ROM to save the printing pattern thus the printer can work independently. In traditional label printers, at first, label printers are connected to the computer to download the printing pattern file from the computer to the printer; then, the printer is removed from the host to work offline. This is very inconvenient when label contents needs to be changed.

### BRIEF SUMMARY OF THE INVENTION

The object of the present invention is to solve the defects in the prior art as described above, to provide a method and system for RFID label printing.

The technical solution of the present invention is to provide a system for RFID label printing, which comprising a label printer and a RFID label, the label printer comprises a printer control panel, wherein the label printer further comprises an antenna for wireless signal transmission between the label printer and the RFID label; a radio frequency (RF) read-write module located between the antenna and the printer for communication with the printer control panel and to transmit and receive RF signals; the RFID label having a loop for receiving energy and schedules from the antenna, a read-write interface for controlling data reading-writing, and a non-volatile memory for saving data.

Advantageously, the label printer further comprises a USB interface on the control panel of the printer for data exchanging with external USB storage device.

Advantageously, the USB interface is a USB host node apparatus.

Advantageously, the RF read-write module having an interface unit connected to the control panel for data exchanging with the control panel of the printer, a TX/RX module for wireless data transmission, a coupling module for data frequency conversion, and a control module connected with the interface unit, TX/RX module, coupling module for controlling the interface unit, TX/RX module and coupling module.

another technical solution of the present invention is to provide a method for RFID printing, which applying a printer control panel, an antenna for wireless signal transmission, a RFID label printer communicating with the printer control panel, a RF read-write module for transmitting and receiving RF signal, and a loop for receiving energy and schedule from the antenna, read-write interface for data reading-writing controlling, non-volatile memory RIFD label for storing data; wherein, comprising the following steps:
A1) configuring printing contents;
A2) printer control panel acquiring printing contents;
A3) RF read-write module communicating with the RFID label in terms of RF signal via antenna;
A4) sensing RF information by the loop, and writing the information into non-volatile memory via read-write interface.

Advantageously, the step A1) further comprises:
A1.1) communicating host printer with the RFID label printer;
A1.2) configuring printing contents in the host printer;
A1.3) transferring the printing contents from host printer to printer control panel.

Advantageously, the step A1) further comprises:

A1.4) copying the printing contents of the host to the USB storage;
A1.5) connecting the USB storage to the RFID label printer.

Advantageously, the A2) further comprises:

A2.1) printer control panel reading the printing contents of the USB storage via USB interface.

Advantageously, after the step A4), the following step is performed:

A5) the RF read-write module reading the contents of RFID label via antenna, if the read contents are the same as the written contents, ending the process; otherwise, feeding back a corresponding error information to the printer control panel.

The benefits of implementing the present invention are, RF chip is installed on the label, RF read-write module is configured on the printer, when printing label, user may read and write RF chip via RF read-write module to stick RFID label with various information and data on the goods and merchandises, it is convenient for the flow of goods and merchandises. As A USB interface is provided on the RIFD label printer also, the label printer may read information saved in the external USB storage via USB interface, for convenience, user may transfer the label contents edited on the computer host to the printer via USB storage.

### BRIEF DESCRIPTION OF THE DRAWINGS

FIG. 1 is a structure diagram of one embodiment of the RFID label printer system, in accordance with the present invention;

FIG. 2 is a structure diagram of another embodiment of the RFID label printer system, in accordance with the present invention;

FIG. 3 is the structure diagram of part of the RFID label printing of the RFID label printer system, in accordance with the present invention;

FIG. 4 is the structure diagram of another part of the RFID label printing of the RFID label printer system, in accordance with the present invention;

FIG. 5 is the flow chart of the first implementation of the RFID label printing method, in accordance with the present invention;

FIG. 6 is the flow chart of the second implementation of the RFID label printing method, in accordance with the present invention.

### DETAILED DESCRIPTION OF THE INVENTION

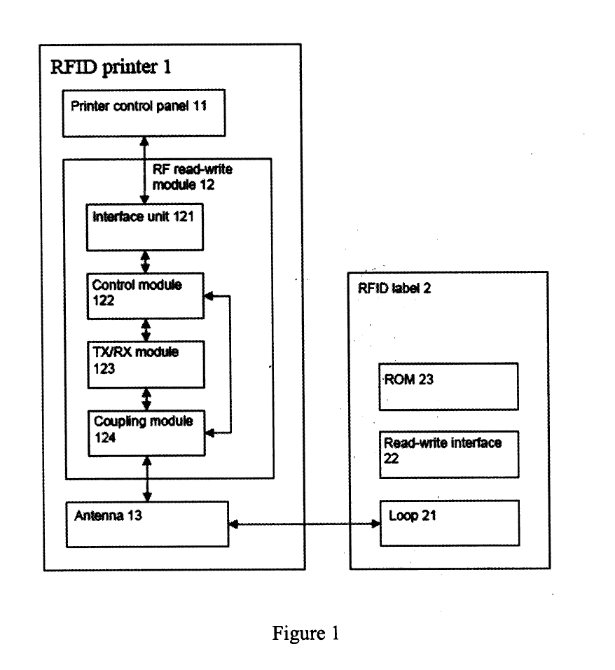

FIG. 1 is a structure diagram of one embodiment of the RFID label printer system, in accordance with the present invention. The RFID label printing system in the present invention comprises a label printer 1 and a RFID label 2, wherein the label printer 1 having a printer control panel 11, an antenna 13, and a RF read-write module 12 between the antenna 13 and printer control panel 11. The antenna 13 is used for wireless signal transmission with the RFID label 2. The RF read-write module 12 is for communicating with the printer control panel and for transmitting and receiving RF signals.

The RF read-write module 12 comprises in interface unit 121 connected with printer control panel 11, a TX/RX module 123, and a coupling module 124. The interface unit 121 is used for data exchange with the printer control panel 11. The TX/RX module 123 is used for wireless signal transmission. The coupling module 124 is used for frequency conversion up and down. The control module 122 is connected with the interface unit 121, TX/RX module 123, and coupling module 124 to control the operations thereof.

The RFID label 2 comprises a loop 21, a read-write interface 22, and a non-volatile memory 23. The loop 21 is used for receiving energy and schedules; the read-write interface 22 is used for controlling data read-write; and the non-volatile memory 23 is used for saving data.

While employing this structure, it is convenient for reading-writing data from/to RFID label 2, the data read-write of the RF chip in RFID label 2 may be accomplished while printing. Therefore, employing this RFID label 2 is very convenient.

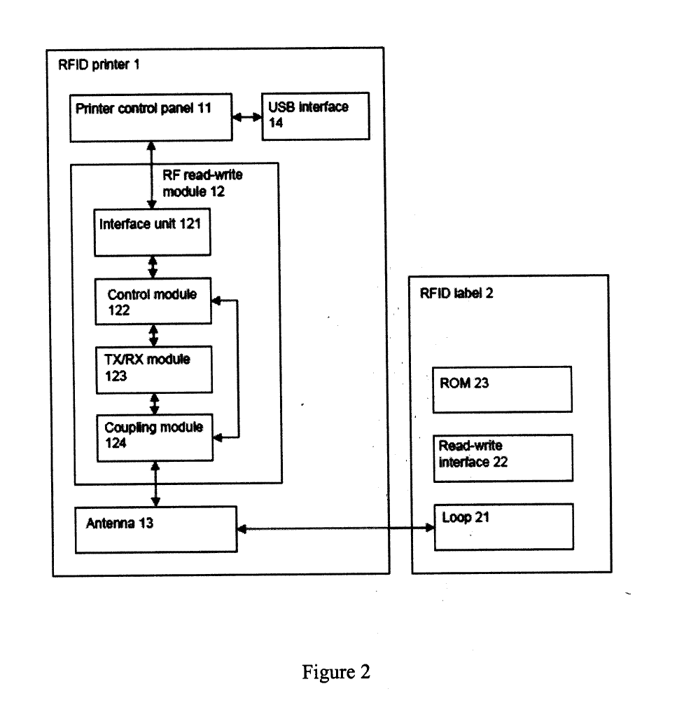

FIG. 2 is a structure diagram of another embodiment of the RFID label printer system, in accordance with the present invention.

Wherein the label printer 1 further comprises a USB interface 14 connected with printer control panel 11, the USB interface 14 is used for data exchanging with external USB storage. And the USB interface 14 is a USB host node apparatus.

In some situations, label printer normally needs to print contents in a fixed pattern only, a few of the variables in the contents needs to be changed, such as initial value of sequence number, number of copies to be printed. In this instance, the printer start to print, it needs only to acquire the pattern information for only once, and then input/amend the information such as sequence number and number of copies to be printed via the keyboard connected with the printer. In this regard, the printer may work offline; that is independently from the computer. Working offline can save resource and space, especially convenient for portable applications. Label printers are often provided with FLASH ROM for storing printing pattern. The key point of working offline is how to transfer the printing pattern to the printer. The method in the prior art is very inconvenient especially when label contents needs to be changed temporarily. Mass storage with USB interface is widely applied nowadays, personal computers are all provided with USB interface now. If label printer is capable of reading information saved in the USB storage via USB interface, then employing USB storage as the carrier of the label contents edited in computers to transfer the label contents would be very convenient. The present invention set a USB interface 14 on the label printer 1, and the USB interface 14 is a USB host node apparatus. Therefore, the label printer may read the printing contents pattern file in the USB storage via the USB interface. Further, keyboard enabling the printer working independently may be connected to the printer via the USB interface. Various operations of the printer may be carried out by the keyboard.

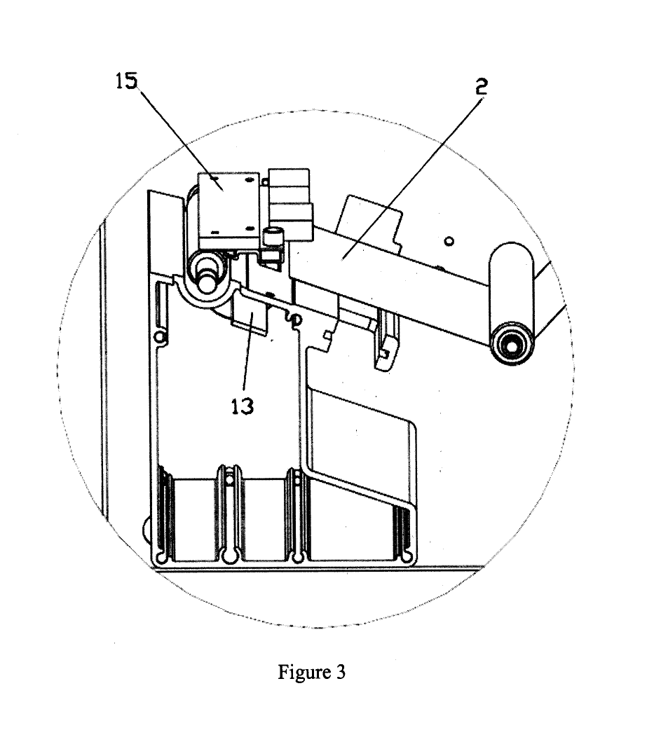

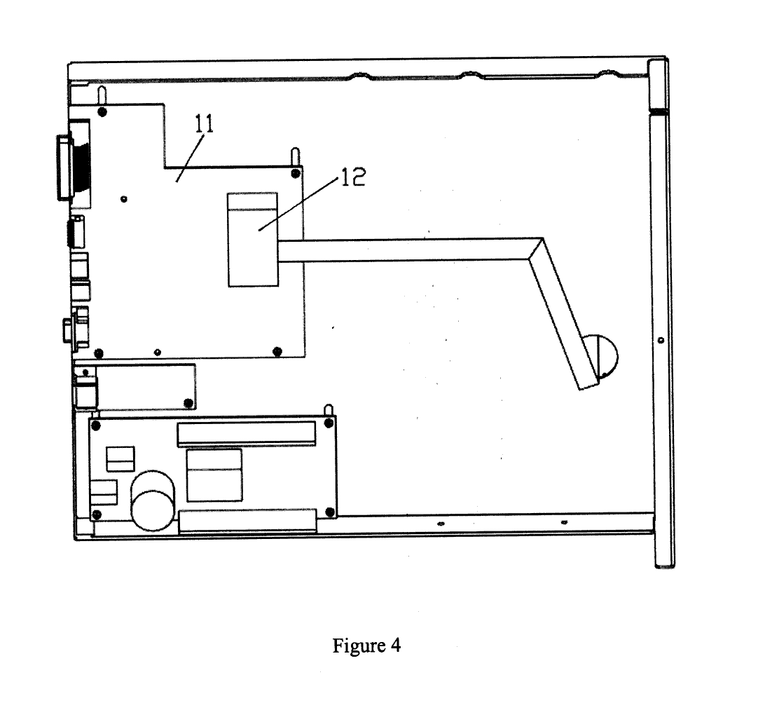

FIGS. 3 and 4 show parts of the structure diagrams of the RFID label printing of the RFID label printer system in the present invention. Wherein the antenna 13 is set around the printer head 15, which is convenient for transmitting information. The wireless signal transmission between the RFID label 2 and label printer 1 is implemented by antenna 13. The RF read-write module 12 is connected with the printer control panel 11.

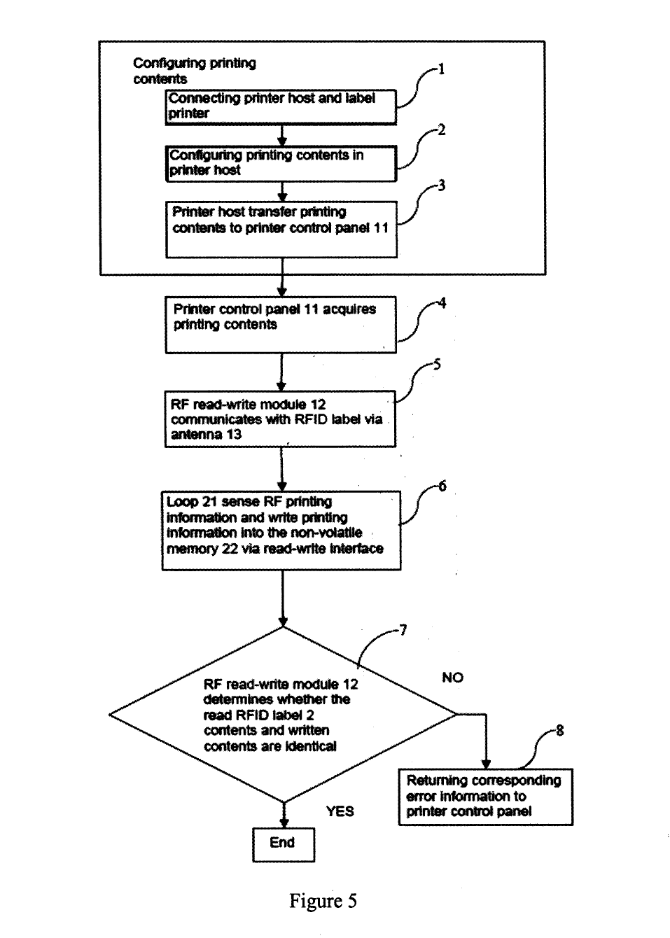

FIG. 5 is the flow chart of the first implementation of the RFID label printing method of the present invention. The present embodiment comprises the following step:
1) connecting the printer host and label printer;
2) configuring the printing contents on the printer host;
3) the printer host transferring the printing contents to the printer control panel 11;
4) the printer control panel 11 acquiring the printing contents;
5) the RF read-write module 12 communicating with the RFID label via antenna 13;
6) the loop 21 sensing the RF printing information and writing printing information into the non-volatile memory 22 via interface;
7) the RF read-write module 12 reading the content in RFID label 2 via antenna 13, if the read content is identical with the written content, finishes the process; otherwise, goes to step 8;
8) returning the corresponding error information to the printer control panel, the control panel then performing corresponding process, such as executing step 5 or implementing other methods.

While employing this method, it is convenient for reading-writing data from/to RFID label 2, and the data read-write of the RF chip in RFID label 2 may be accomplished in printing.

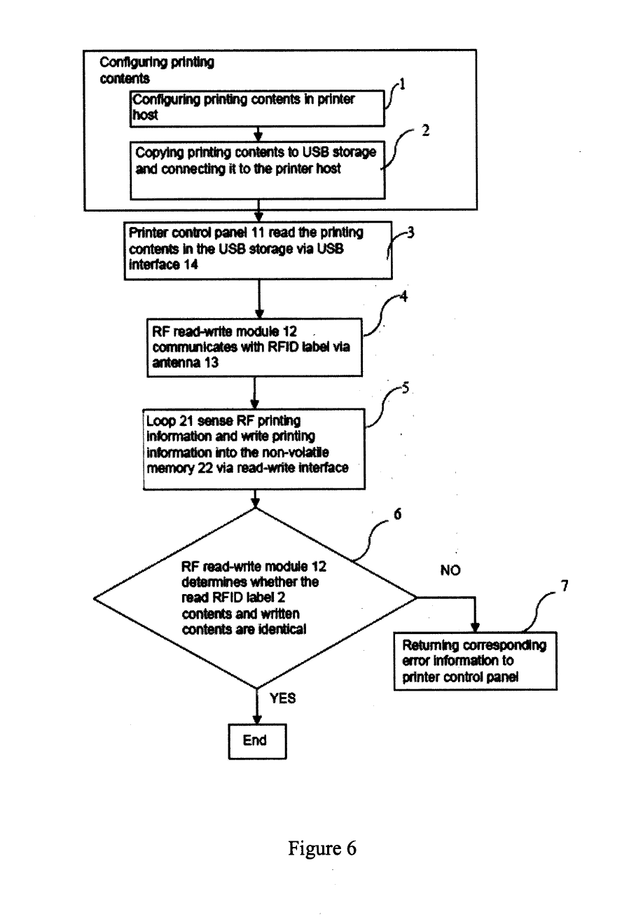

FIG. 6 is the flow chart of the second embodiment of the RFID label printing method of the present invention. The present embodiment comprises the following steps:
1) configuring printing contents in the printer host;
2) copying the printing contents to the USB storage and connecting the USB storage to the printer host;
3) the printer control panel 11 reading the printing contents stored in the USB storage via USB interface 14;
4) the RF read-write module 12 communicating with RFID label via antenna 13;
5) the loop 21 sensing the RF printing information and writing printing information into the non-volatile memory 22 via interface.
6) the RF read-write module 12 reading the content in RFID label 2 via antenna 13, if the read content is identical with the written content, finishes the process; otherwise, goes to step 7;
7) returning the corresponding error information to the printer control panel, the control panel will then performing corresponding process, such as executing step 4 or implementing other methods.

In the present embodiment, the USB interface is a USB host apparatus, when using, storing the edited label contents in the USB storage at first, then plugging the USB storage directly onto the printer; so, it is very convenient in using.

1. A system for RFID label printing, comprising a label printer (1) and a RFID label (2), said label printer (1) comprises a printer control panel (11); wherein the label printer (1) further comprises an antenna (13) for wireless signal transmission between the label printer (1) and RFID label (2), a radio frequency read-write module (12) between the antenna (13) and printer control panel (11) for communication with the printer control panel and transmitting/receiving RF signals; said RFID label (2) comprises a loop (21) for receiving energy and schedules from the antenna (13), a read-write interface (22) for controlling data read-write, and a non-volatile memory (23) for storing data.

2. The system as in claim 1, wherein said label printer (1) further comprises a USB interface (14) set on the control panel (11) of the printer for data exchanging with external USB storage device.

3. The system as in claim 2, wherein said USB interface (14) is a USB host node apparatus.

4. The system as in claim 1, wherein said RF read-write module (12) comprises an interface unit (121) connected to the printer control panel (11) for data exchanging with the printer control panel (11), a TX/RX module (123) for wireless data transmission, a coupling module (124) for data frequency conversion, a control module (122) connected with the interface unit (121), TX/RX module (123) and coupling module (124) for controlling said interface unit (121), TX/RX module (123) and coupling module (124).

5. A method for RFID printing, applying a printer control panel, a antenna for wireless signal transmission, a RFID label printer communicating with the printer control panel and RF read-write module for transmitting/receiving RF signal, and a loop for receiving energy and schedule from said antenna, read-write interface for data read-write control, and a non-volatile memory RIFD label for storing data, wherein, comprising the steps of:
A1) configuring printing contents;
A2) acquiring printing contents by the printer control panel;
A3) the RF read-write module communicating with the RFID label in terms of RF signal via antenna;
A4) the loop sensing the RF information, and the read-write interface writing information into the non-volatile memory.

6. The method as in claim 5, wherein the step A1) further comprises:
A1-1) connecting the host printer and RFID label printer;
A1-2) configuring the printing contents in the host printer;
A1-3) transferring the printing contents from the host printer to the printer control panel.

7. The method as in claim 5, wherein the step A1) comprises:
A1-4) copying the printing contents that set in the host to the USB storage;
A1-5) connecting the USB storage with the RFID label printer.

8. The method as in claim 5, wherein said A2) further comprises:
A2-1) the printer control panel reading the printing contents in the USB storage via the USB interface.

9. The method as in claim 5, wherein following step A4), further comprising the steps of:
A5) the RF read-write module reading the contents in RFID label via antenna, if the read contents are the same as to the written contents, then ends the process; otherwise, feeding back a corresponding error information to the printer control panel.
